(19) United States
(12) Patent Application Publication
(10) Pub. No.: US 2023/0023877 A1
(43) Pub. Date: Jan. 26, 2023

(54) Restaurant and Bar Information Mobile Application

(71) Applicant: BarHopper, LLC, Traverse City, MI (US)

(72) Inventor: James Harvey, Traverse City, MI (US)

(21) Appl. No.: 17/488,777

(22) Filed: Sep. 29, 2021

Related U.S. Application Data
(60) Provisional application No. 63/084,596, filed on Sep. 29, 2020.

(51) Int. Cl. G06Q 30/02; G06V 20/52

(52) U.S. Cl. CPC G06Q 30/0282; G06Q 30/0201; G06V 20/52

(57) ABSTRACT

A mobile application and system for users to gather information regarding bars, restaurants, and other establishments. The system allows users of a mobile application to search details specific in real-time information about local bars and restaurants. Managers can update information in real time regarding detail specific information of the bar or restaurant at any given time. For example, a user can search if a bar or restaurant has free Wi-Fi, keno/lottery, happy hour, kitchen open late, group discounts, and/or no cover. The user is permitted to search if the establishment has karaoke, live music, piano bar, comedy, trivia, jukebox, DJ, open mic and/or adult entertainment. The user can search if the establishment has dancing, a rooftop bar, waterview, patio, deck, fireplace, LGBTQ friendly, pet and/or kid friendly. The bar manager updates these criteria in information in real-time enabling a user to search the most up-to-date information about an establishment.

### CROSS REFERENCE TO RELATED APPLICATIONS

This application claims priority and benefit to U.S. provisional application Ser. No. 63/084,596 filed on Sep. 29, 2020.

### TECHNICAL FIELD

The present specification generally relates to mobile applications and, more specifically, a mobile application and system for enabling users to gather information regarding bars and restaurants.

### BACKGROUND

Commonly known restaurant and bar information platforms do not provide for comprehensive and/or real time searching capabilities. Merchants of all kinds have been marketing themselves—their products, services and offerings—for many years. Newspaper ads, yellow pages ads, coupons and billboards are just a few of the ways merchants have promoted themselves. With the advent of the Internet, the World Wide Web and the ability for consumers to access, consume and even contribute information to a large audience, new avenues for marketing were born. Specialized rating and review websites were born, such as YELP, TRIPADVISOR.COM and OPENTABLE.COM. And traditional directories were born anew as YP.COM and YELLOW PAGES.COM. These are only just a few of the national reaching websites. Local review websites are also popular. Newspapers and magazines also provide a forum for consumer comments. The number of places online where merchants are listed is large. When the number of rating and review websites is added to this, the number of location online where a merchant is mentioned in some way is very large. Based on the number of online references to a merchant, it is difficult for a merchant to manage and maintain accurate information about the business—such as, for example, hours of operation, payment types accepted—on the large number of directory and listing websites. Moreover, it is difficult for merchants to monitor and respond to ratings and review provided on the large number of rating and review web sites.

Accordingly, there exists a need in the art to provide a restaurant information gathering and providing system overcoming the aforementioned disadvantages.

### SUMMARY

A system for enabling users to gather information about an establishment, the system having an owner platform, the owner platform enabling creating an owner operated account associated with an establishment on the establishment owner platform, the establishment having a predetermined set of criteria, uploading changes to the predetermined set of criteria in real time, a corresponding customer mobile device enabling searching of said real-time predetermined set of criteria in the customer mobile application, and displaying corresponding establishments matching a set of criteria searched by the user of the customer mobile application. In some embodiments, the system includes a camera positioned in the establishment enabling a customer to view live images and/or video of the establishment. In some systems, live images and/or video of the establishment are displayed based on a set of search criteria set by the customer.

A method of enabling users to gather information about an establishment owner platform and a corresponding customer mobile device, the method having the steps of creating an owner operated account associated with an establishment on the establishment owner platform, the establishment having a predetermined set of criteria, altering said predetermined set of criteria based on present offerings, uploading said predetermined set of criteria, enabling searching of said predetermined set of criteria in the customer mobile application, and displaying corresponding establishments matching a set of criteria searched by the user of the customer mobile application. In some embodiments, a camera is positioned in the establishment enabling a customer to view live images and/or video of the establishment. In some methods, live images and/or video of the establishment are displayed based on a set of search criteria set by the customer.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 depicts a flow chart descripting the system as disclosed herein according to one or more embodiments shown and described herein;

FIG. 2 depicts a screen shot from the login of the system allowing the bar manager to login according to one or more embodiments shown and described herein;

FIG. 3 depicts a screen shot of the bar owner management section of the system according to one or more embodiments shown and described herein;

FIG. 4 depicts a screen shot of the bar owner management section allowing a bar manager to create a new bar of the system according to one or more embodiments shown and described herein;

FIG. 5 depicts a screen shot of the bar owner management section allowing a bar manager to manage bar details of the system according to one or more embodiments shown and described herein;

FIG. 6 depicts a screen shot of the bar owner management section allowing a bar manager to manage bar details of the system according to one or more embodiments shown and described herein;

FIG. 7 depicts a screen shot of the bar owner management section allowing a bar manager to manage users of the system according to one or more embodiments shown and described herein;

FIG. 8 depicts a screen shot of the bar owner management section allowing a bar manager to manage bars of the system according to one or more embodiments shown and described herein;

FIG. 9 depicts a screen shot from the mobile application as seen by the user allowing the user to search aspects of a bar or restaurant according to one or more embodiments shown and described herein;

FIG. 10 depicts a screenshot from the mobile application as seen by the user where the user has selected free Wi-Fi and karaoke as search criteria according to one or more embodiments shown and described herein;

FIG. 11 depicts a screenshot from the mobile application as seen by the user allowing the user to rate the bar or restaurant according to one or more embodiments shown and described herein;

FIG. 12 depicts a screenshot from the mobile application as seen by the user allowing the user to log in to the mobile application according to one or more embodiments shown and described herein;

FIG. 13 depicts a screenshot displaying the users “favorites” according to one or more embodiments shown and described herein;

FIG. 14 depicts a screenshot from the mobile application as seen by the user allowing the user to rate the bar or restaurant according to one or more embodiments shown and described herein;

FIG. 15 depicts a screenshot from the mobile application as seen by the user displaying information about the bar or restaurant after the user has searched based on selected search criteria according to one or more embodiments shown and described herein;

FIG. 16 depicts an alternative screenshot from the mobile application as seen by the user displaying information about the bar or restaurant after the user has searched based on selected search criteria according to one or more embodiments shown and described herein; and

### DETAILED DESCRIPTION

The system of the present specification discloses a mobile application and system for users to gather information regarding bars, restaurants, and other establishments. The system is configured to allow users of a mobile application to search details specific in real-time information about local bars and restaurants. Furthermore, our managers are able to update information in real time regarding detail specific information of the bar or restaurant at any given time. For example, a user is able to search if a bar or restaurant has free Wi-Fi, keno/lottery, happy hour, kitchen open late, group discounts, and/or no cover. Further, the user is permitted to search if the establishment has karaoke, live music, piano bar, comedy, trivia, jukebox, DJ, open mic and/or adult entertainment. Even further, the user is able to search if the establishment has dancing, a rooftop bar, waterview, a patio, a deck, fireplace, LGBTQ friendly, pet friendly and/or kid friendly. Correspondingly, the bar manager is able to update all of these criteria in information in real-time enabling a user to search the most up-to-date information about an establishment.

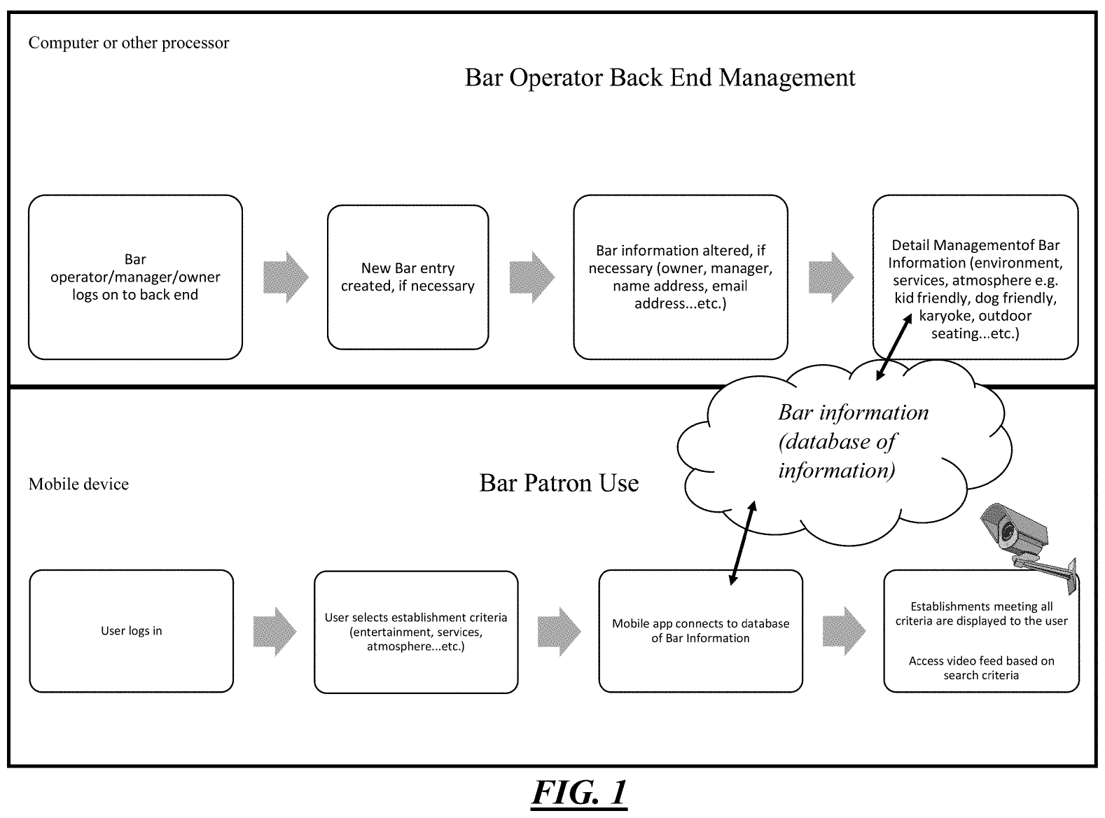

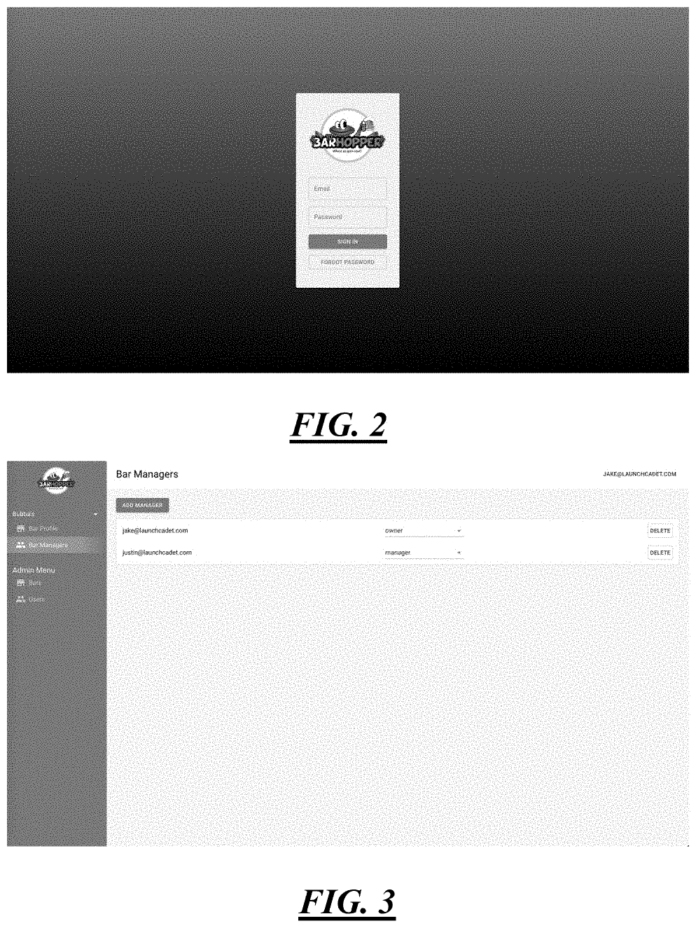

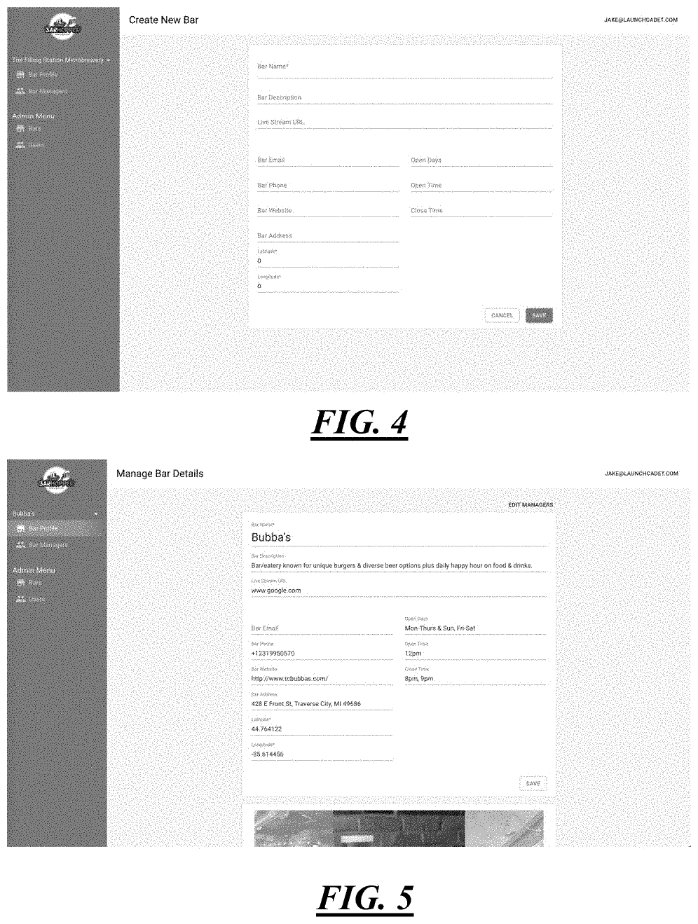

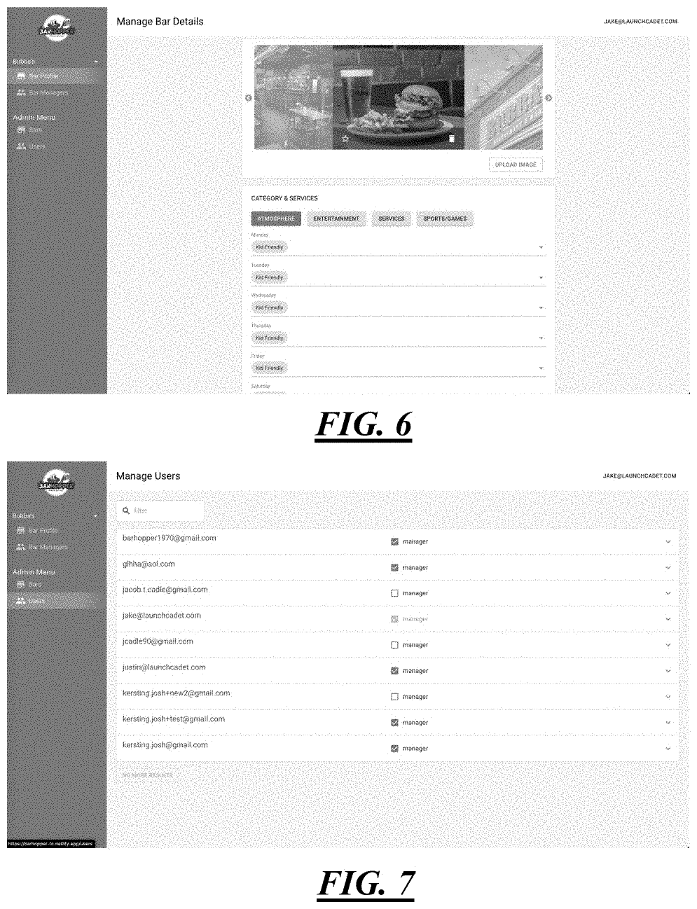

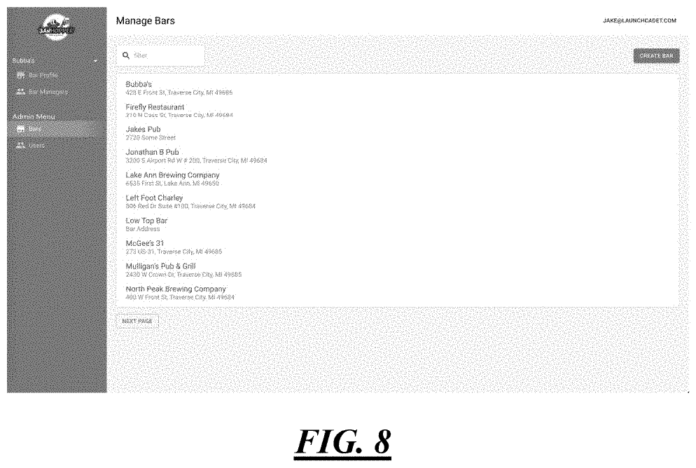

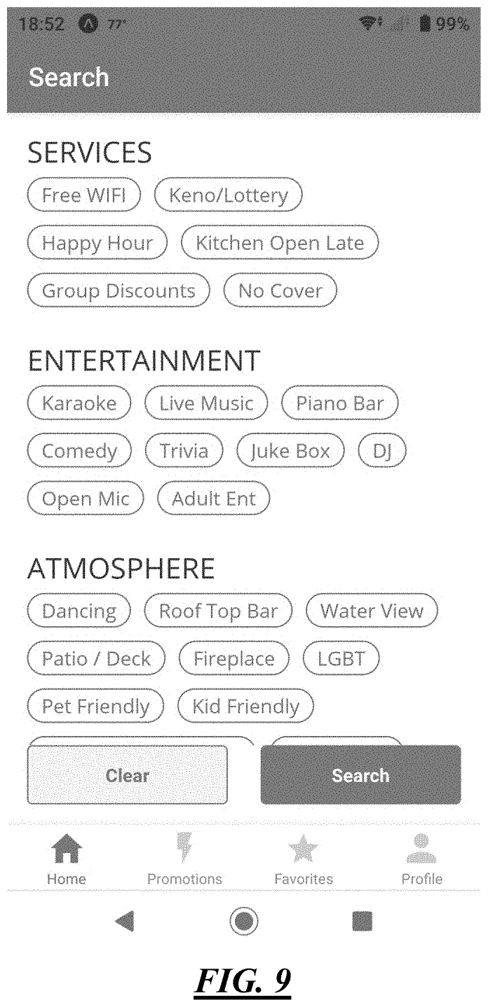

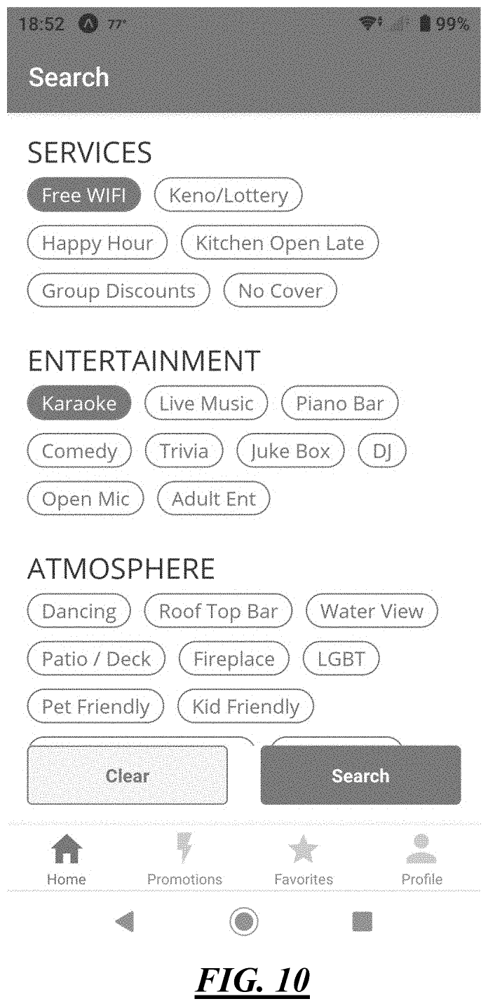

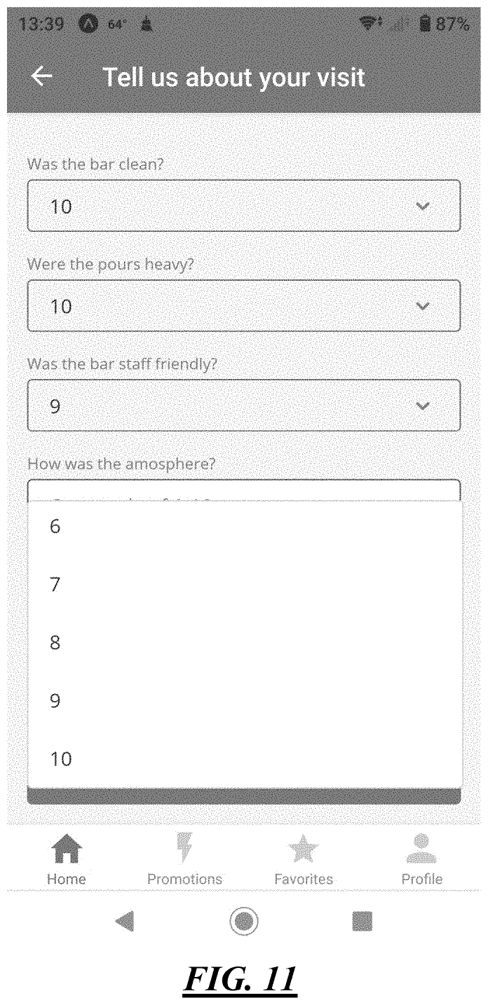

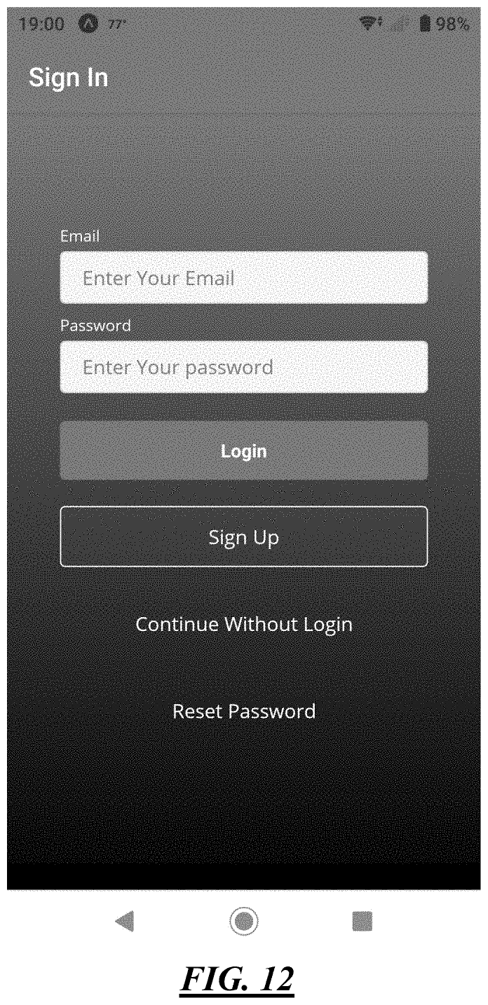

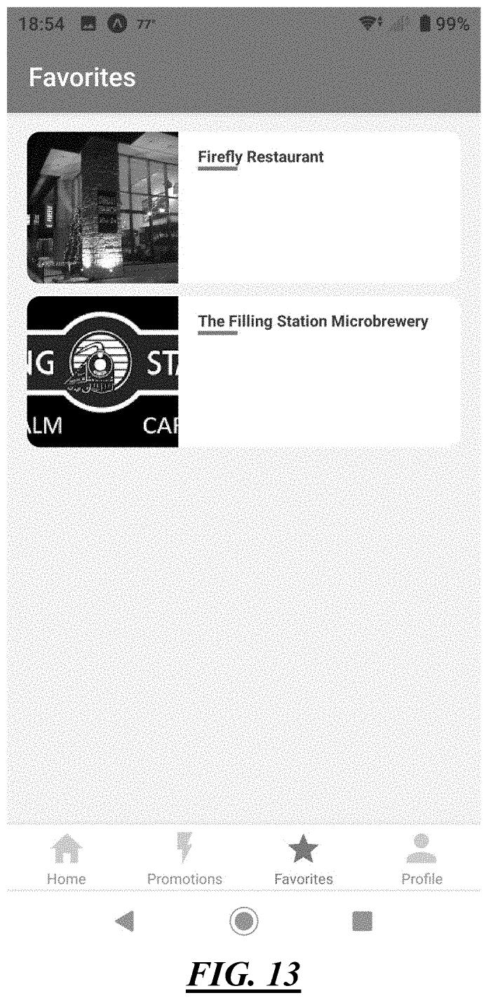

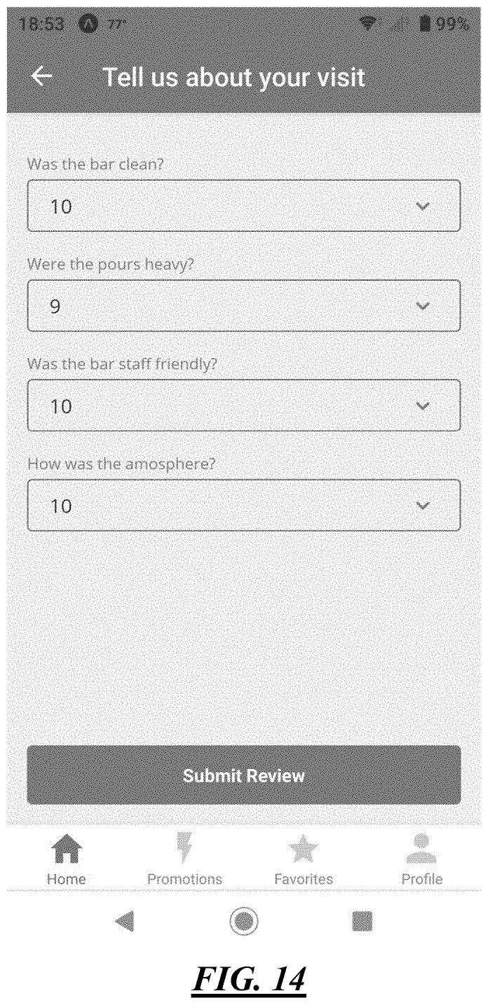

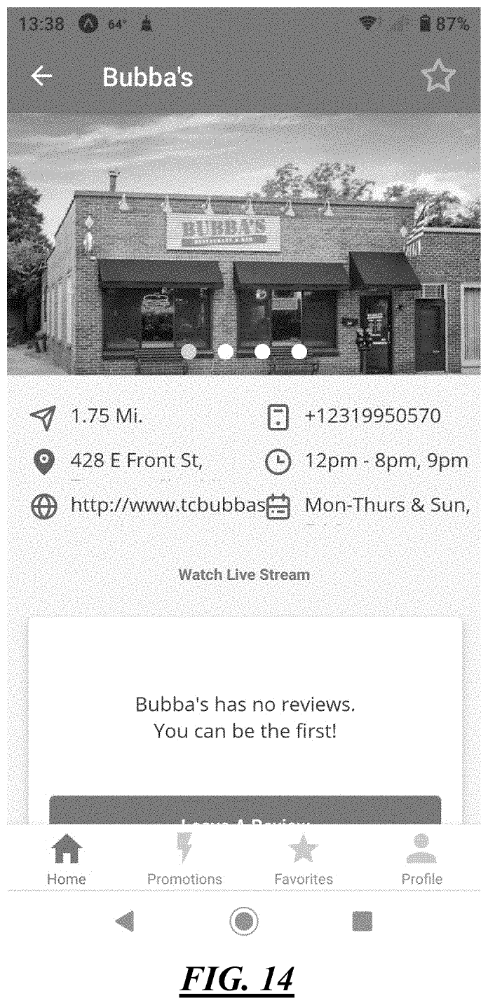

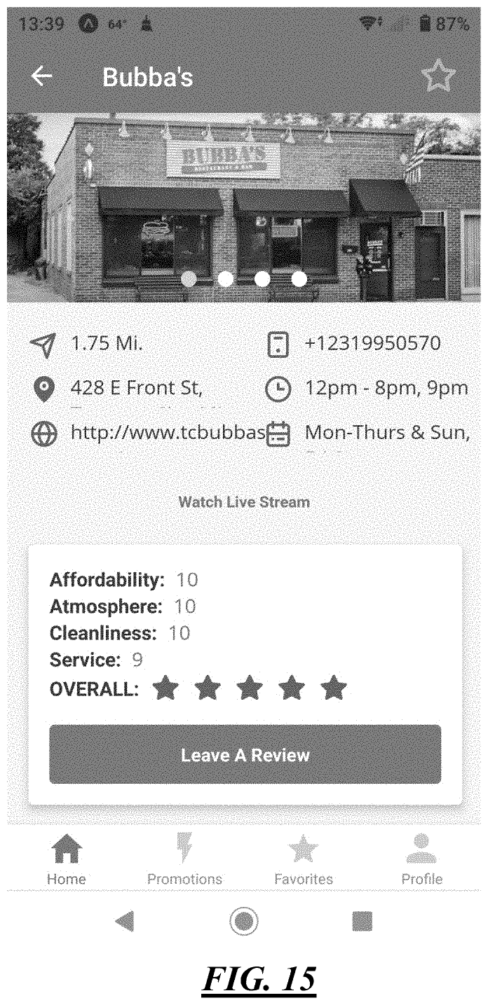

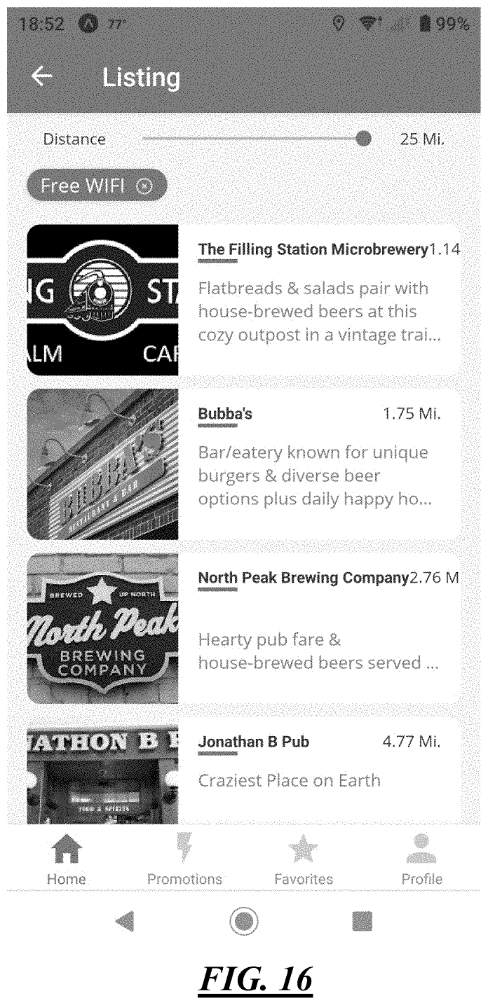

Referring now to FIG. 1, the system is broken down into bar operator back end management and bar patron use. When the bar operator intends to use the system, the bar operator or owner or manager logs into the back end of the system. A new bar entry is created if necessary. Bar information is altered, if necessary, to update the owner, manager, name, address, email information. Detail management of the bar (environment, services, atmosphere E dot G dot kid friendly, dog friendly, karaoke, outdoor seating . . . etc.) is then entered into the system. The information, specifically bar information, is uploaded into the cloud of bar information database of information.

Still referring to FIG. 1, the bar patron use of the mobile application system is also shown. In this process, the user logs in and the user selects establishment criteria (entertainment, services, atmosphere . . . etc.) The mobile application then connects to the database of bar information as uploaded by the bar operator/manager/owner. Establishments meeting all criteria are then displayed to the user. The user may then select to view the camera from inside of the establishment to view how busy the establishment is.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any Utility application) cover all such changes and modifications that are within the scope of the claimed subject matter.

What is claimed is:

1. A system for enabling users to gather information about an establishment, the system comprising:
an owner platform, the owner platform enabling creating an owner operated account associated with an establishment on the establishment owner platform, the establishment having a predetermined set of criteria, uploading changes to the predetermined set of criteria in real time;
a corresponding customer mobile device enabling searching of said real-time predetermined set of criteria in the customer mobile application; and
displaying corresponding establishments matching a set of criteria searched by the user of the customer mobile application.

2. The system for enabling users to gather information about an establishment of claim 1 wherein the system includes a camera positioned in the establishment enabling a customer to view live images and/or video of the establishment.

3. The system for enabling users to gather information about an establishment of claim 2 wherein live images and/or video of the establishment are displayed based on a set of search criteria set by the customer.

4. A method of enabling users to gather information about an establishment owner platform and a corresponding customer mobile device, the method comprising the steps of:
creating an owner operated account associated with an establishment on the establishment owner platform, the establishment having a predetermined set of criteria;
altering said predetermined set of criteria based on present offerings;
uploading said predetermined set of criteria;
enabling searching of said predetermined set of criteria in the customer mobile application;
displaying corresponding establishments matching a set of criteria searched by the user of the customer mobile application.

5. The method of enabling users to gather information about an establishment owner platform and a corresponding customer mobile device of claim 4 wherein a camera is positioned in the establishment enabling a customer to view live images and/or video of the establishment.

6. The method of enabling users to gather information about an establishment owner platform and a corresponding customer mobile device of claim 4 wherein live images and/or video of the establishment are displayed based on a set of search criteria set by the customer.
